(19) United States
(12) Patent Application Publication
(10) Pub. No.: US 2015/0355456 A1
(43) Pub. Date: Dec. 10, 2015

(54) ELECTROWETTING FLUIDS

(71) Applicant: MERCK PATENT GMBH, Darmstadt (DE)

(72) Inventors: LOUISE D. FARRAND, Dorset (GB); Nathan SMITH, Southampton (GB); Andrew CORBETT, Westbury (GB); Anthony LAWRENCE, Manchester (GB)

(73) Assignee: MERCK PATENT GMBH, Darmstadt (DE)

(21) Appl. No.: 14/761,038

(22) PCT Filed: Dec. 16, 2013
(86) PCT No.: PCT/EP2013/003793

§ 371 Date: Jul. 15, 2015

(30) Foreign Application Priority Data
Jan. 15, 2013 (EP) 13000208.2

(51) Int. Cl. G02B 26/00; C09B 31/14; C09B 31/043

(52) U.S. Cl. CPC G02B 26/005; C09B 31/043; C09B 31/14

(57) ABSTRACT

This invention relates to electrowetting fluids, the use of these fluids for the preparation of an electrowetting displays devices, and electrowetting display devices comprising such fluids.

This invention relates to an electrowetting fluid, the use of such electrowetting fluid for the preparation of an electrowetting display device, and electrowetting display devices comprising such fluids.

Electrowetting displays (EWD) offer a new route to e-paper that combines video rate response times with a reflective colour display that can be read in bright sunlight, and show low power consumption relative to a typical LCD display. Electrowetting (ew) is a physical process where the wetting properties of a liquid droplet are modified by the presence of an electric field. This effect can be used to manipulate the position of a dyed fluid within a pixel. For example, a dye dissolved in a non-polar (hydrophobic) solvent can be mixed with a clear colourless polar solvent (hydrophilic), and when the resultant biphasic mixture is placed on a suitable electrowetting surface, for example a highly hydrophobic dielectric layer, an optical effect can be achieved. When the sample is at rest, the (coloured) non-polar phase will wet the hydrophobic surface, and spread across the pixel. To the observer, the pixel would appear coloured. When a voltage is applied, there is an electromechanical attractive force between the ions in the polar solvent and the electrode. This causes the polar phase to wet the surface, and the coloured non-polar phase is thus driven to a contracted state, for example in one corner of the pixel. To the observer, the pixel would now appear transparent. The invention of electrowetting fast switching displays was reported in Nature (R. A. Hayes, B. J. Feenstra, Nature 425, 383 (2003)). Electrowetting displays are also described in WO 2005/098524, WO 2010/031860, and WO 2011/075720.

The colour properties of the non-polar phase will be dictated by the dye chromophores present in the non-polar phase, and the cell architecture. Since the observed effect is based on surface interactions, there is an advantage to decreasing the cell gap as much as possible to maximise the effect of the surface on the material layer. Typically, if the material layer is too thick, the surface effects will be lessened, and higher voltages will be required to drive the display. However, thinner material layers provide a challenge with regards to achieving strong colour saturation, as the thinner the layer, the lower the absorption of the layer. For EWD, there is a requirement for dyed non-polar solutions with high colour intensity, especially for black solutions with strong colour intensity. Therefore, the object of this invention is to provide new electrowetting display materials.

This object is solved by an electrowetting fluid according to claim 1, by the use of such electrowetting fluid for the preparation of an electrowetting display device and by an electrowetting display device comprising such electrowetting fluid. The present invention also provides new dyes and dye mixtures especially for use in EWD with high absorbance and increased solubility in non-polar solvents. In particular, the present invention provides a non-polar black solution with strong colour intensity that still appears black in a thin cell, particularly in cells with thicknesses<20 μm, preferably under 10 μm, and most preferably <5 μm. The new non-polar black solution shows a broad spectral absorbance from 380-730 nm by using a combination of dyes.

The electrowetting fluid of the invention is comprised of novel dyes which have improved solubility in non-polar solvents, especially in decane, combined with a high extinction coefficient to enable a high absorption in a thin layer. Preferably, the new dyes also have a reduced polarisability. So, the invention provides an oil phase for an EWD that remains electrically inert in order to avoid any unwanted electrostatic interactions between the oil phase and the surface. Such interactions can cause the oil phase to spread back across the surface of the substrate and reduce the transparency of the ON state of an EWD. In particular, the oil phase has a dielectric constant as low as possible, preferably <2.5, even more preferably <2.0. In particular, the invention provides EWD fluids with

1) High dye solubility in non-polar solvents by use of novel dyes,
2) A unique combination of dyes to achieve high colour intensity, and a good neutral black, and
3) Dyes with reduced polarisability.

Mixtures of dyes can also be used to obtain the correct electrowetting fluid shade; for example a black from single component mixtures of brown and blue or yellow, magenta and cyan dyes. Similarly shades can be tuned by for example by adding small quantities of separate dyes to modify the colour of the electrowetting fluid (e.g. 95% yellow and 5% cyan to get a greener yellow shade). Furthermore, mixtures of dyes having the same chromophore but with different solubilising groups can also be used to further increase absorbance. It is possible to use mixtures of homologue dyes comprising dyes with different linear or branched alkyl groups, preferably with C8-C20 groups; for example mixtures of dyes with 2-ethylhexyl, n-octyl, 3,5,5-trimethylhexyl, 2-butyloctyl, 2-hexyldecyl, 2-octyldecyl, n-decyl, n-undecyl, n-dodecyl, tetradecyl, and/or pentadecyl groups.

The electrowetting fluid of the invention comprises at least one dye according to Formula I and/or at least one dye of Formula II

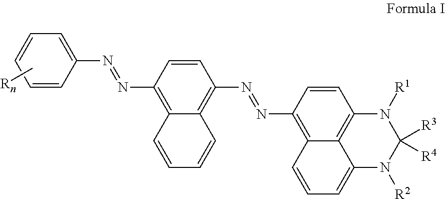

wherein
R=independently linear or branched, substituted or unsubstituted, saturated or unsaturated alkyl or cycloalkyl, OR′, or an electron-withdrawing group, and n=1-5 and R′=independently linear or branched alkyl;
R¹ and R²=independently linear or branched, substituted or unsubstituted alkyl, where one or more non-adjacent carbon atoms may be replaced by O, S and/or N, substituted or unsubstituted cycloalkyl, substituted or unsubstituted aryl, and
R³ and R⁴=independently H or linear or branched, substituted or unsubstituted alkyl, substituted or unsubstituted cycloalkyl, substituted or unsubstituted aryl, or R³ and R⁴ forming a cycloaliphatic ring;

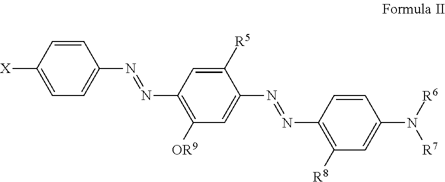

wherein
X is H or linear or branched, substituted or unsubstituted alkyl or substituted or unsubstituted cycloalkyl;
R⁵ is H or linear or branched, substituted or unsubstituted alkyl; substituted or unsubstituted cycloalkyl, or substituted or unsubstituted aryl;
R⁶ and R⁷=independently linear or branched, substituted or unsubstituted alkyl, substituted or unsubstituted cycloalkyl or substituted or unsubstituted aryl,
R⁸ is H or linear or branched, substituted or unsubstituted alkyl, substituted or unsubstituted cycloalkyl, substituted or unsubstituted aryl or CH₃NH—CO—O—, and
R⁹ is linear or branched, substituted or unsubstituted alkyl,

### Preferred Variants of Formula I:

The term “electron-withdrawing group” is well known in the art and refers to the tendency of a substituent to attract valence electrons from neighbouring atoms; in other words the substituent is electronegative with respect to neighbouring atoms. Examples of electron-withdrawing groups include NO₂, CN, halogen, acyl, trifluoromethoxy, trifluoromethyl, SO₂F, and CO₂R, SO₂R, SO₂NRR or SO₂NHR, with R being independently linear or branched alkyl, preferably C1-C4 alkyl. Preferred electron-withdrawing groups are NO₂, CN, Br, Cl, SO₂NRR or SO₂NHR.

R may be chiral.

Preferably, n is 1-2, especially 1.

R′ is preferably linear alkyl, especially methyl.

Preferably, R is a C1-C12 alkyl group, especially a C1-C6 alkyl group. Preferably, R¹ and R² are independently aryl or C1-C15 alkyl, especially C2-C12 alkyl, optionally substituted with OAlkyl or ester groups, especially with OCH₃.

R³ and/or R⁴ may be chiral. Preferably, R³ and R⁴ are independently C1-C20 alkyl, especially C1-C15 alkyl.

Especially preferred dyes according to Formula I comprise the preferred variants of R, R¹ and R², and R³ and R⁴; in particular dyes with R=C1-C6 alkyl, R¹ and R²=independently aryl or C2-C12 alkyl, and R³ and R⁴=independently C1-C15 alkyl.

Further preferred dyes of Formula I are those wherein R¹ and R² are identical and/or R³ and R⁴ are different. In particular, dyes with identical R¹ and R² and different R³ and R⁴ are preferred, especially dyes wherein R¹ and R²=aryl or C2-C12 alkyl and one of R³ and R⁴=CH₃ or C₂H₅ and the other=C6-C15 alkyl.

### Preferred Variants of Formula II;

Preferably, X is C1-C20 alkyl or cycloalkyl, especially C1-C15 alkyl or cycloalkyl.

Preferably, R⁵ is H or C1-C6 alkyl, especially H or C1-C3 alkyl.

Preferably, R⁶ and R⁷ are independently C1-C20 alkyl, especially C6-C15 alkyl. Optionally R⁶ and/or R⁷ may be substituted with OAlkyl or ester groups, especially with OCH₃. R⁶ and/or R⁷ may be chiral.

Preferably, R⁸ is C1-C6 alkyl, especially C1-C3 alkyl.

Preferably, R⁹ is C1-C20, especially C1-C15 alkyl.

Especially preferred dyes according to Formula II comprise the preferred variants of X, R⁵, R⁶ and R⁷, R⁸ and R⁹; in particular dyes with X=C2-C15 alkyl, R⁶=H or C1-C3 alkyl, R⁶ and R⁷=independently C6-C15 alkyl, R⁸=C1-C3 alkyl, and R⁹=C1-C15 alkyl.

Especially preferred dyes of Formula II comprise identical R⁶ and R⁷.

It is especially advantageous to use the dyes listed in Tables 1 and 2.

TABLE 1

| Dye No. | Structure |
|---|---|
| Dye 1 | 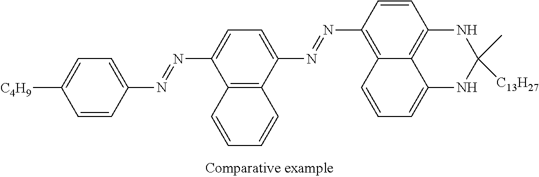 |
| Dye 2 | 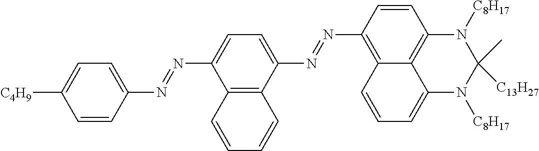 |
| Dye 3 | 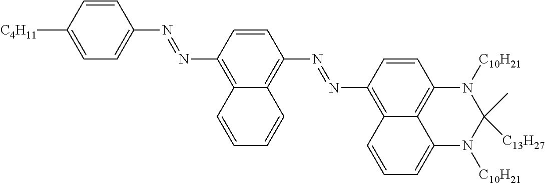 |
| Dye 4 | 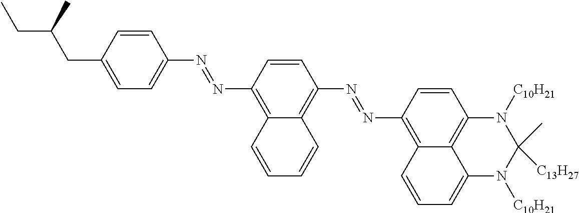 |
| Dye 5 | 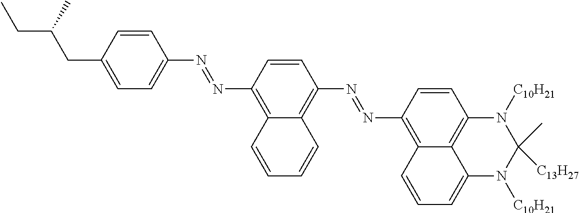 |
| Dye 6 | 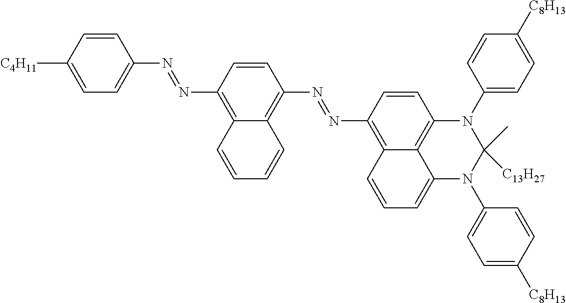 |
| Dye 7 | 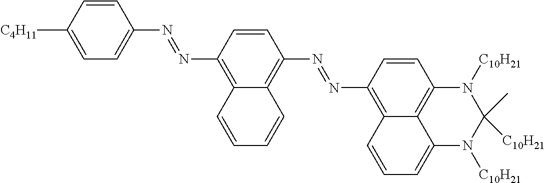 |
| Dye 8 | 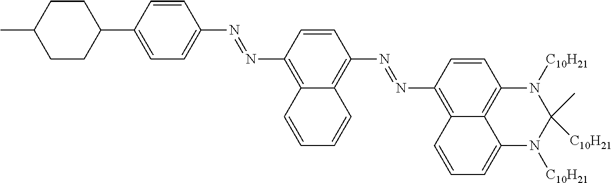 |
| Dye 9 | 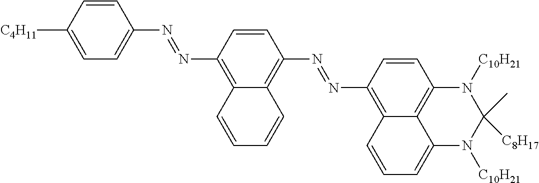 |
| Dye 10 | 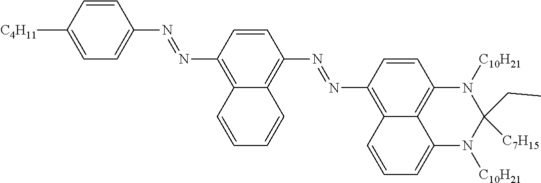 |
| Dye 11 | 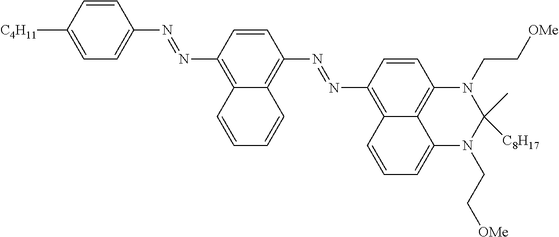 |
| Dye 12 | 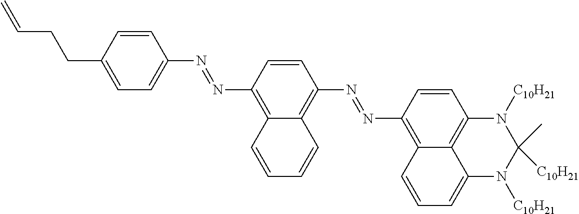 |
| Dye 13 | 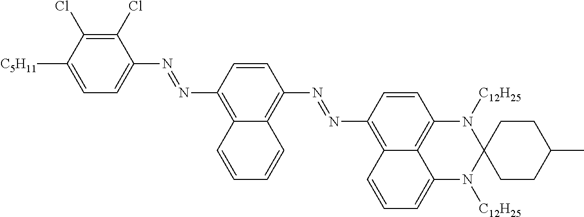 |

TABLE 2

| Dye No. | Structure |
|---|---|
| Dye 14 | 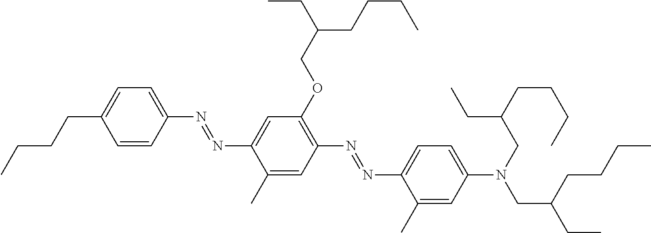 [SMILES: CCCCc1ccc(/N=N/c2cc(OCC(CC)CCCC)c(/N=N/c3ccc(N(CC(CC)CCCC)CC(CC)CCCC)cc3C)cc2C)cc1] |
| Dye 15 | 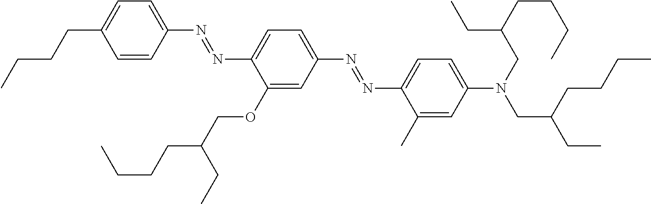 [SMILES: CCCCc1ccc(/N=N/c2ccc(/N=N/c3ccc(N(CC(CC)CCCC)CC(CC)CCCC)cc3C)cc2OCC(CC)CCCC)cc1] |
| Dye 16 | 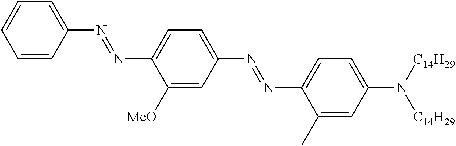 |
| Dye 17 | 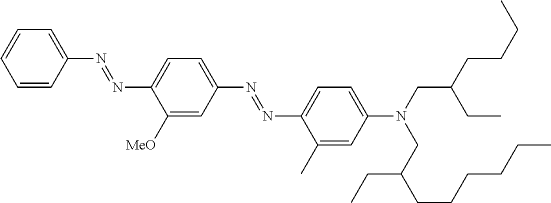 [SMILES: CCCCCCC(CC)CN(CC(CC)CCCC)c1ccc(/N=N/c2ccc(/N=N/c3ccccc3)c(OC)c2)c(C)c1] |
| Dye 18 | 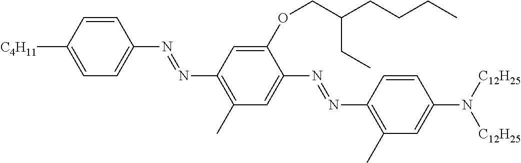 |
| Dye 19 | 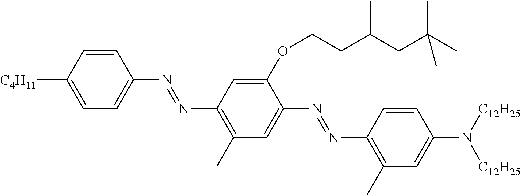 |
| Dye 20 | 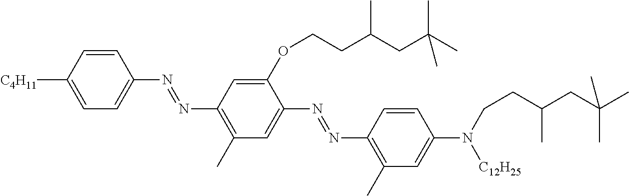 |
| Dye 21 | 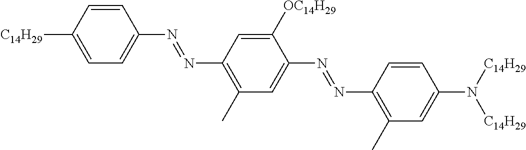 |
| Dye 22 | 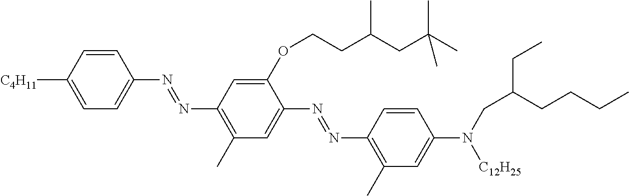 |
| Dye 23 | 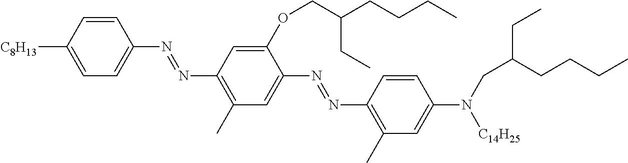 |

The dyes of Formulas I and/or II may be used alone or as mixtures. Especially preferred are mixtures of the dyes listed in Tables 1 and/or 2, in particular a mixture of Dye 2 and Dye 14.

Dyes according to the invention may also be used in combination with other dyes suitable for EWD. Especially, mixtures of dyes according to Formula III, Formula IV, Formula V, Formula VI and/or Formula VII can be used

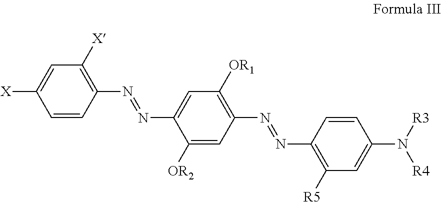

wherein
X and X′ are independently of one another H or an electron-withdrawing group;
R₁ and R₂ are independently of one another groups are linear or branched, substituted or unsubstituted alkyl groups where one or more non-adjacent carbon atoms may be replaced by O, S and/or N, preferably C8-C20;
R₃ and R₄ are independently of one another groups are linear or branched, substituted or unsubstituted alkyl groups where one or more non-adjacent carbon atoms may be replaced by O, S and/or N, preferably C8-C20;
R5 is a methyl or methoxy group;
and the dye comprises at least one electron-withdrawing group;

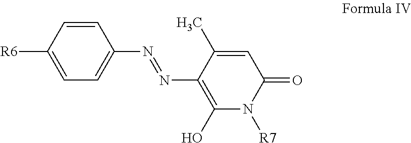

### Wherein

R₆ and R₇ are independently of one another groups are linear or branched, substituted or unsubstituted alkyl groups where one or more non-adjacent carbon atoms may be replaced by O, S and/or N, preferably C8-C20;

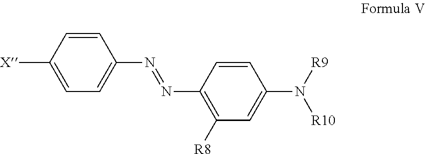

wherein
X″ is an electron-withdrawing group;
R₈ is a methyl or methoxy group;
R₉ and R₁₀ are independently of one another groups are linear or branched, substituted or unsubstituted alkyl groups where one or more non-adjacent carbon atoms may be replaced by O, S and/or N; preferably C8-C20;

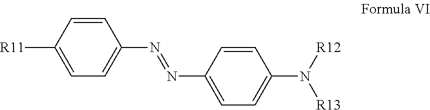

wherein
R₁₂ and R₁₃ are independently of one another groups are linear or branched, substituted or unsubstituted alkyl groups where one or more non-adjacent carbon atoms may be replaced by O, S and/or N; preferably C8-C20;
R₁₁ is an alkyl or alkoxy group with at least 3 carbon atoms;

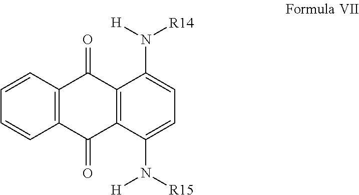

wherein
R₁₄ and R₁₅ are independently of one another groups are linear or branched, substituted or unsubstituted alkyl groups where one or more non-adjacent carbon atoms may be replaced by O, S and/or N; preferably C8-C20;

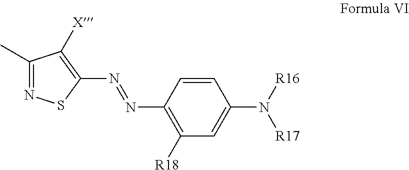

wherein
X′″ is an electron-withdrawing group;
R₁₆ and R₁₇ are independently of one another groups are linear or branched, substituted or unsubstituted alkyl groups where one or more non-adjacent carbon atoms may be replaced by O, S and/or N, preferably C8-C20.
R₁₈ is NHCOR with R=linear or branched C1-C10 alkyl groups, preferably NHCOCH₃.

The term “electron-withdrawing group” is well known in the art and refers to the tendency of a substituent to attract valence electrons from neighbouring atoms; in other words the substituent is electronegative with respect to neighbouring atoms. Examples of electron-withdrawing groups include NO₂, CN, halogen, acyl, trifluoromethoxy, trifluoromethyl, SO₂F, and CO₂R, SO₂R, SO₂NRR or SO₂NHR, with R being independently linear or branched alkyl, preferably C1-C4 alkyl. Preferred electron-withdrawing groups are NO₂, CN, Br, Cl, SO₂NRR or SO₂NHR.

Preferably, dyes of Formula I with linear or branched C8-C20 alkyl groups are used, especially those with additional NO₂ and/or CN groups. In particular, dyes of Table 3, especially Dye 23, provide advantageous mixtures with the dyes of the invention.

TABLE 3

| Dye No. | Structure |
|---|---|
| Dye 24 | 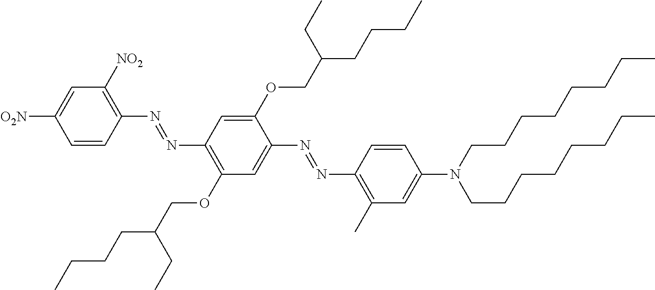 [SMILES: CCCCCCCCN(CCCCCCCC)c1ccc(/N=N/c2cc(OCC(CC)CCCC)c(/N=N/c3ccc([N+](=O)[O-])cc3[N+](=O)[O-])cc2OCC(CC)CCCC)c(C)c1] |
| Dye 25 | 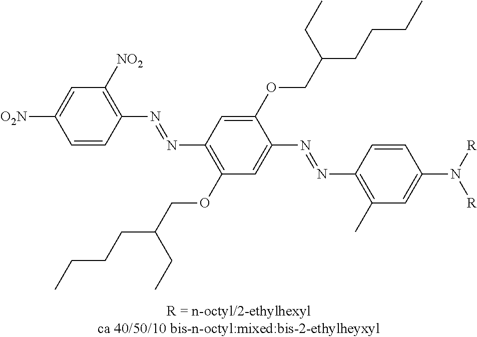 |
| Dye 26 | 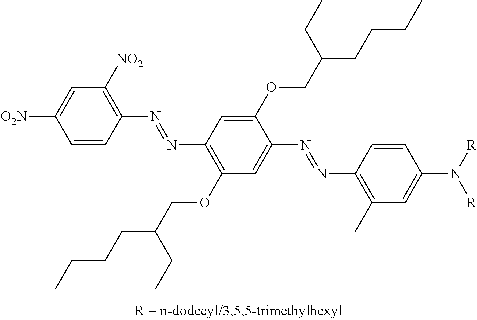 |
| Dye 27 | 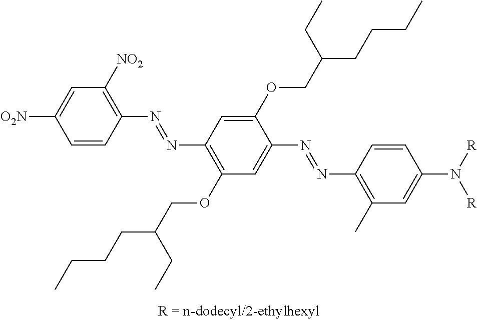 |
| Dye 28 | 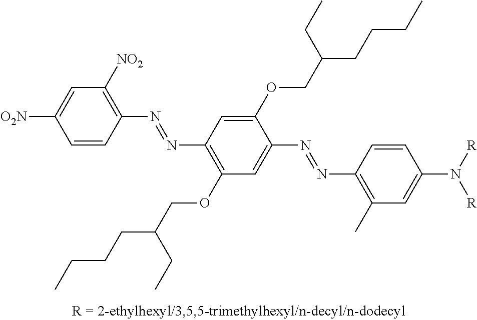 |
| Dye 29 | 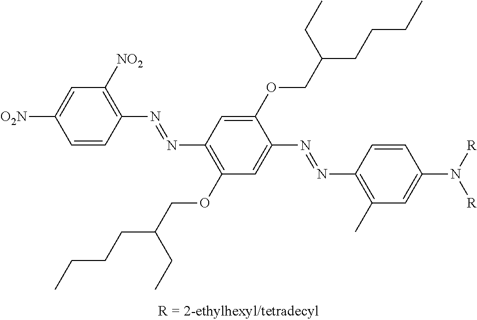 |
| Dye 30 | 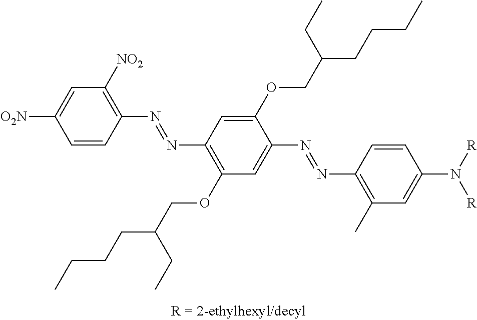 |

A further subject of the invention are dyes of Formula I

wherein R=linear or branched, substituted or unsubstituted, saturated or unsaturated alkyl or cycloalkyl,
R¹ and R²=independently linear or branched, substituted or unsubstituted alkyl, substituted or unsubstituted cycloalkyl, substituted or unsubstituted aryl,
R³ and R⁴=independently H or linear or branched, substituted or unsubstituted alkyl, substituted or unsubstituted cycloalkyl, substituted or unsubstituted aryl, or R³ and R⁴ forming a cycloaliphatic ring

### and Formula II

wherein
X=H or linear or branched, substituted or unsubstituted alkyl or substituted or unsubstituted cycloalkyl;
R⁵=H or linear or branched, substituted or unsubstituted alkyl, substituted or unsubstituted cycloalkyl, or substituted or unsubstituted aryl,
R⁶ and R⁷=independent of each other linear or branched, substituted or unsubstituted alkyl, substituted or unsubstituted cycloalkyl, substituted or unsubstituted aryl,
R⁸=H or linear or branched, substituted or unsubstituted alkyl, substituted or unsubstituted cycloalkyl or substituted or unsubstituted aryl, and
R⁹=linear or branched, substituted or unsubstituted alkyl
and the processes of their preparation as disclosed in Schemes 1 and 2.

The following schemes show by way of example for Dye 2 and Dye 13 the synthesis of dyes of the invention of Formulas I and II which can be carried out by processes and under conditions known to the person skilled in the art; further details are given in the examples:

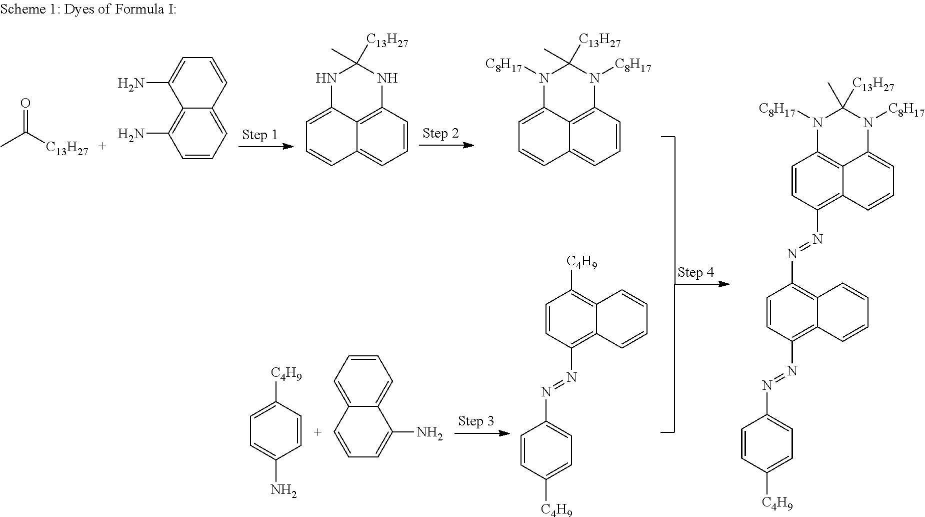

The preparation of dyes of Formula I by a 2 step procedure under convenient conditions as known in the art is exemplified in the following scheme for 6-((E)-(4-((E)-(4-butylphenyl)diazenyl)naphthalen-1-yl)diazenyl)-2-methyl-1,3-dioctyl-2-tridecyl-2,3-dihydro-1H-perimidine

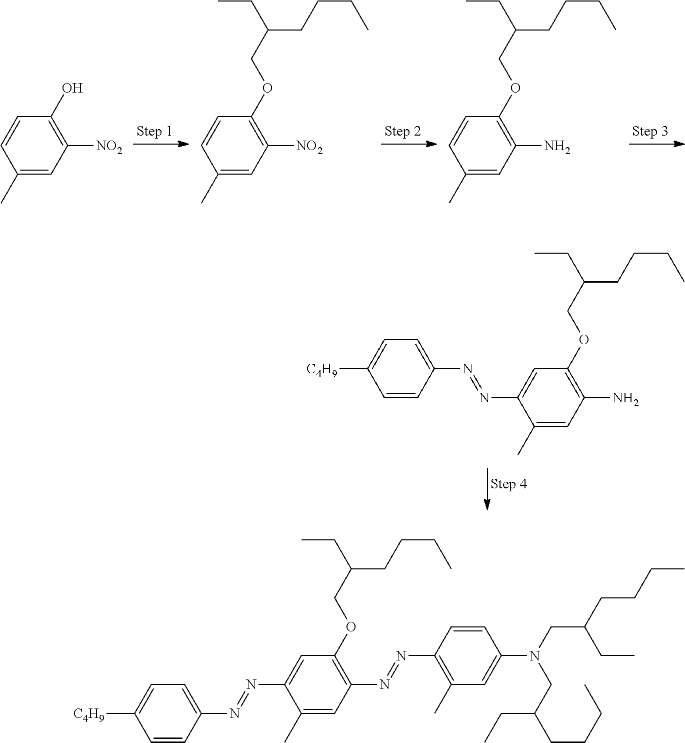

The preparation of dyes of Formula II by a 4 step procedure under convenient conditions as known in the art is exemplified in the following scheme for 4-((E)-(4-((E)-(4-butylphenyl)diazenyl)-2-(2-ethylhexyloxy)-5-methylphenyl)diazenyl)-N,N-bis(2-ethylhexyl)-3-methylaniline

Dyes of Formula III may be prepared as shown in Scheme 3 by way of example for dye 23:

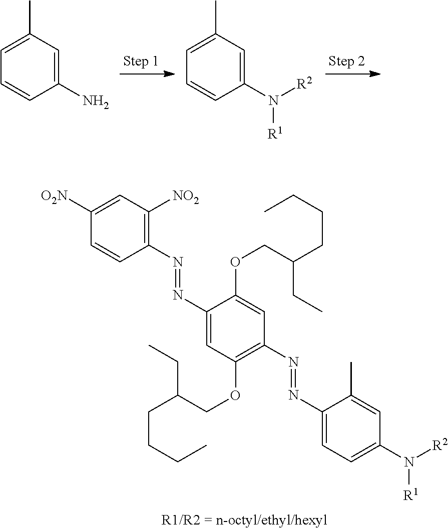

The preparation of dyes of Formula III by a 2 step procedure under convenient conditions as known in the art is exemplified in the following scheme for 4-((E)-(4-((E)-(2,4-Dinitrophenyl)diazenyl)-2,5-bis(2-ethylhexyloxy)phenyl)diazenyl)-3-methyl-N,N-octyl/ethylhexyl-aniline:

The preparation of further dyes can be carried out analogously to the illustrative reactions shown above and in the examples.

Electrowetting fluids of the invention are primarily designed for use in electrowetting display devices. So, further subjects of the invention are electrowetting display devices comprising such fluids.

A typical electrowetting display device preferably consists of the dyes in a low polar or non-polar solvent along with additives to improve properties, such as stability and charge. Examples of such electrowetting fluids are well described in the literature, for example in Nature (R. A. Hayes, B. J. Feenstra, Nature 425, 383 (2003)), WO 2005/098524, WO 2010/031860, and WO 2011/075720.

A preferred solvent choice would display a low dielectric constant (<10, more preferably <5), high volume resistivity (about 10¹⁵ ohm-cm), low viscosity (less than 5 cst), low water solubility, a high boiling point (>80° C.) and a refractive index and density similar to that of the polar phase to be used. Tweaking these variables can be useful in order to change the behaviour of the final application. Preferred solvents are often non-polar hydrocarbon solvents such as the Isopar series (Exxon-Mobil), Norpar, Shell-Sol (Shell), Sol-Trol (Shell), naphtha, and other petroleum solvents, as well as long chain alkanes such as dodecane, tetradecane, decane and nonane). These tend to be low dielectric, low viscosity, and low density solvents.

The disclosures in the cited references are expressly also part of the disclosure content of the present patent application. In the claims and the description, the words “comprise/comprises/comprising” and “contain/contains/containing” mean that the listed components are included but that other components are not excluded. All process steps described above and below can be carried out using known techniques and standard equipments which are described in prior art and are well-known to the skilled person. The following examples explain the present invention in greater detail without restricting the scope of protection.

### EXAMPLES

All chemicals are purchased from Sigma-Aldrich. All chemicals are purchased at the highest grade possible and are used without further purification unless otherwise stated.

The following abbreviations are used:

IMS industrial methylated spirit;

### NMP N-Methylpyrrolidone

### THF Tetrahydrofuran

### DCM Dichloromethane

Mp melting point

### Comparative Example

### 6-((E)-(4-((E)-(4-Butylphenyl)diazenyl)naphthalen-1-yl)diazenyl)-2-methyl-2-tridecyl-2,3-dihydro-1H-perimidine (Dye 1)

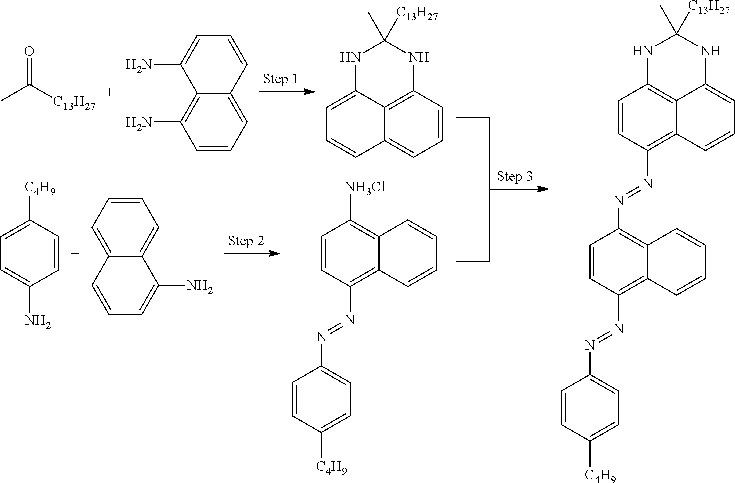

### Step 1: 2-Methyl-2-tridecyl-2,3-dihydro-1H-perimidine

A mixture of 1,8-naphthalenediamine (15.8 g, 0.10 mol) and 2-pentadecanone (24.9 g, 0.11 mol) in 2-propanol (50 ml) is heated to 50° C. to give a clear solution. 35% HCl (2 ml) is then added, causing a precipitate to form. The mixture is heated to reflux for 5 minutes, after which time all solid had dissolved. The solution is allowed to cool to ambient temperature and used directly.

### Step 2: (E)-4-((4-Butylphenyl)diazenyl)naphthalen-1-aminium chloride

4-Butylaniline (14.9 g, 0.100 mol) is dissolved in 2-propanol (100 ml) and cooled to 0° C. in an ice/salt bath. 5N HCl (45 ml, 0.225 mol) is added keeping the temperature<5° C. A solution of sodium nitrite (7.2 g, 0.105 mol) in water (ca 20 ml) is then added over 30 minutes at 0-5° C., then stirred a further 30 minutes. Meanwhile, 1-naphthylamine (14.3 g, 0.100 mol) is slurried in water (250 ml) and 5N HCl (25 ml, 0.125 mol) added. The 1-naphthylamine hydrochloride suspension is then decanted into the diazonium salt solution and a solution of sodium acetate trihydrate (26 g, 0.19 mol) in water (100 ml) is added dropwise. After stirring overnight, the resultant free-flowing purple-black slurry is filtered off and washed with cold water. The solid is boiled in 2-propanol for 15 minutes with stirring, then allowed to cool to ambient temperature, before solid is collected by filtration. After drying for 16 h at 40° C., the pure title compound is obtained as shiny green crystals (24.4 g, 80%).

### Step 3: 6-((E)-(4-((E)-(4-Butylphenyl)diazenyl)naphthalen-1-yl)diazenyl)-2-methyl-2-tridecyl-2,3-dihydro-1H-perimidine

4-((4-Butylphenyl)diazenyl)naphthalen-1-aminium chloride (5.1 g, 15 mmol) is slurried in acetic acid (70 ml) with stirring and cooled to 5° C. Water (30 ml) is added followed by 35% HCl (5 ml). A solution of sodium nitrite (1.1 g, 16 mmol) in water (10 ml) is added over ca 10 minutes at 2-5° C. In a separate vessel, acetone (200 ml) and ethanol (200 ml) are stirred, 10% sulfamic acid solution (20 ml) is added followed by 2-methyl-2-tridecyl-2,3-dihydro-1H-perimidine solution (16.5 mmol), Ice (200 g) is added in portions whilst the above diazonium salt solution is decanted in, keeping solid ice present throughout the addition. The reaction is allowed to stir overnight, then the supernatant is decanted off to leave a gummy black solid. Crude material is then purified over silica gel eluting with toluene. The pure fractions are combined and evaporated. The resultant oil is redissolved in dichloromethane (200 ml) and basic alumina (1.3 g) is added. After stirring for 30 minutes, the solution is filtered and methanol (500 ml) is added. The solution is allowed to stand and slowly evaporate, which produced a precipitated gummy solid. The mother liquor is decanted off, and the residue boiled for 20 minutes in methanol (200 ml), which caused the gum to solidify. The resultant solid is filtered off and dried at 40° C. to give the pure dye as a blue-black solid (6.0 g, 59%); mp=79-81° C.; λₘₐₓ (toluene) 571 nm (33,500), FWHM 144 nm; ¹H nmr (300 MHz, CDCl₃) δ 0.89 (3H, t, J 7.5), 0.98 (3H, t, J 7.5), 1.20-1.60 (27H, m), 1.69 (2H, m), 1.77 (2H, m), 2.74 (2H, t, J 7.5), 4.28 (1H, br. s), 4.80 (1H, br. s), 6.55 (1H, d, J 8.5), 6.59 (1H, d, J 8.0), 7.37 (2H, d, J 8.5), 7.46 (1H, t, J 8.0), 7.71 (2H, m), 7.92-8.08 (4H, m), 8.15 (1H, d, J 8.5), 8.42 (1H, d, J 8.0), 9.03 (1H, m), 9.12 (1H, m).

### Example 1

### 6-((E)-(4-((E)-(4-butylphenyl)diazenyl)naphthalen-1-yl)diazenyl)-2-methyl-1,3-dioctyl-2-tridecyl-2,3-dihydro-1H-perimidine (Dye 2)

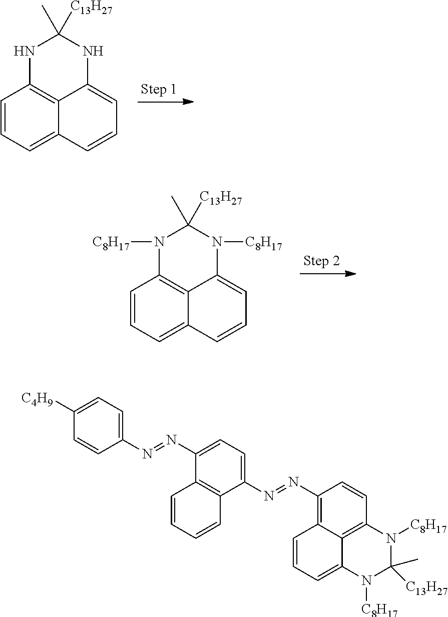

### Step 11: 2-Methyl-1,3-dioctyl-2-tridecyl-2,3-dihydro-1H-perimidine

A stirred mixture of 2-methyl-2-tridecyl-2,3-dihydro-1H-perimidine (18.3 g, 50 mmol) (prepared as described in step 1 in comparative example 1), sodium bicarbonate (21.0 g, 250 mmol), 2-methylpyrrolidinone (30 ml), and 1-bromooctane (24.2 g, 125 mmol) is heated in an oil bath at 105° C. for 48 h. The reaction was allowed to cool then poured into water (500 ml). The mixture is extracted with hexane (2×100 ml) then dried (MgSO₄). On evaporation, the residue is purified over silica gel, eluting with hexane then 10% dichloromethane/90% hexane. The pure title compound is isolated as a pale yellow oil (18.4 g, 62%) on evaporation of pure combined fractions.

### Step 2: 6-((E)-(4-((E)-(4-butylphenyl)diazenyl)naphthalen-1-yl)diazenyl)-2-methyl-1,3-dioctyl-2-tridecyl-2,3-dihydro-1H-perimidine

4-((4-Butylphenyl)diazenyl)naphthalen-1-aminium chloride (step 2 in comparative example) (5.1 g, 15 mmol) is slurried in acetic acid (70 ml) with stirring and cooled to 5° C. Water (30 ml) is added followed by 35% HCl (6 ml). A solution of sodium nitrite (1.1 g, 16 mmol) in water (10 ml) is added over 10 minutes at 2-5° C. In a separate vessel, 2-methyl-1,3-dioctyl-2-tridecyl-2,3-dihydro-1H-perimidine (8.9 g, 15 mmol) is dissolved in acetone (250 ml) and 2-propanol (250 ml). Ice (200 g) is added in portions whilst the above diazonium salt solution is decanted in, keeping solid ice present throughout the addition. The reaction is allowed to stir overnight then the supernatant was decanted off to leave a black tar. The material is dissolved in hexane (300 ml), washed with 2N NaOH (2×100 ml) and dried (MgSO₄). The solution is applied to a column of silica gel, and the required pure dye obtained by eluting with an increasing gradient of dichloromethane (0-20%) in hexane. The pure dye is obtained as a black tar (1.9 g, 14%) after drying for 24 h at 70° C. under <10 mbar vacuum; λₘₐₓ (hexane) 577 nm (37,500), FWHM 133 nm, 419 nm (13,000); ¹H nmr (300 MHz, CDCl₃) δ 0.80-0.92 (9H, m), 0.97 (3H, t, J 7.5), 1.00-1.50 (45H, m), 1.55-1.88 (10H, m), 2.73 (2H, t, J 8.0), 3.20-3.56 (4H m), 6.55 (1H, d, J 9.0), 6.67 (1H, d, J 8.0), 7.37 (2H, d, J 8.5), 7.41 (1H, t, J 8.0), 7.70 (2H, m), 7.92-8.08 (4H, m), 8.21 (1H, d, J 9.0), 8.42 (1H, d, J 8.0), 9.03 (1H, m), 9.14 (1H, m).

### Example 2

### 4-((E)-(4-((E)-(4-butylphenyl)diazenyl)-2-(2-ethylhexyloxy)-5-methylphenyl)diazenyl)-N,N-bis(2-ethylhexyl)-3-methylaniline (Dye 14)

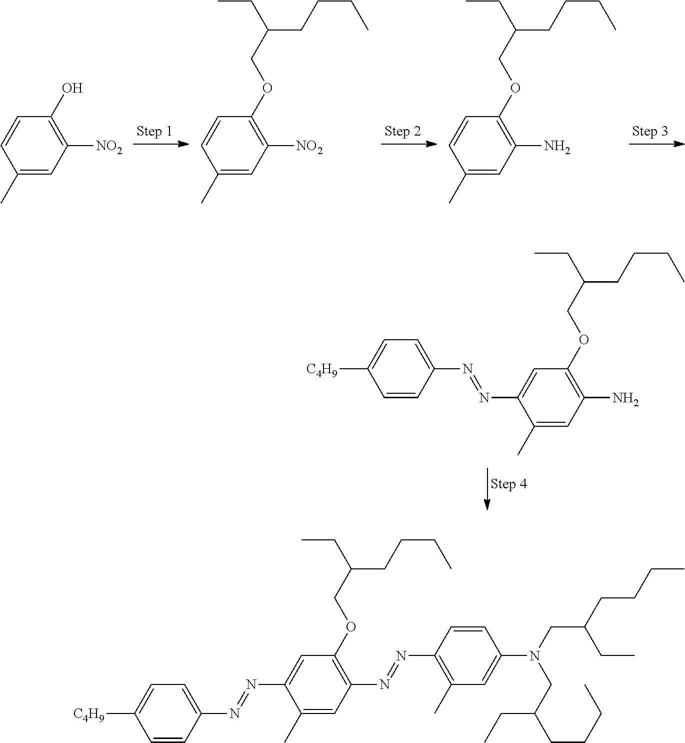

### Step 1: 1-(2-Ethylhexyloxy)-4-methyl-2-nitrobenzene

4-Methyl-2-nitrophenol (30.6 g, 0.2 mol) is dissolved in IMS (150 ml) and the stirred solution is treated with a solution of potassium hydroxide (12.3 g, 0.22 mol) in IMS (100 ml). To the resultant stirred suspension is added 2-ethylhexyl bromide (42.5 g, 0.22 mol) and the mixture is heated under reflux overnight. Water (50 ml) and an additional portion of 2-ethylhexyl bromide (21.2 g, 0.11 mol) are then added and the mixture is heated further under reflux overnight. The cooled reaction mixture is poured into water (1.5 L) containing potassium hydroxide (10 g) and the mixture is extracted with dichloromethane (2×300 ml). The dichloromethane solution was dried (MgSO₄), filtered and evaporated to afford the crude product as an oil. The crude product is dissolved in a minimum volume of heptane, applied to silica gel and eluted with an increasing gradient of dichloromethane (0-25%) in heptane. The product fractions are combined and evaporated to afford the title compound as a yellow oil (29.1 g, 55%).

### Step 2: 2-(2-Ethylhexyloxy)-5-methylaniline

1-(2-Ethylhexyloxy)-4-methyl-2-nitrobenzene (29.0 g, 0.11 mol) is dissolved in methanol (400 ml), 10% Pd/C catalyst (2.9 g) is added and the mixture is hydrogenated for 72 h under 1 atm. of hydrogen gas. The catalyst is filtered off and the solution evaporated to give the title compound as an oil (24.3 g). The crude product is dissolved in a minimum volume of heptane, applied to silica gel and eluted with an increasing gradient of dichloromethane (0-40%) in heptane. The product fractions are combined and evaporated to afford the pure title compound as an orange-red oil (20.3 g, 78%) that darkened on standing.

### Step 3: 4-((4-butylphenyl)diazenyl)-2-(2-ethylhexyloxy)-5-methylaniline

4-Butylaniline (9.0 g, 60.3 mmol) is dissolved in 2-propanol (100 ml) and the stirred solution is cooled externally in an ice/salt bath to <5° C. (internal temp.). 5N Hydrochloric acid (45 ml) is added to this solution slowly and then sodium nitrite (4.35 g, 63.0 mmol) in water (15 ml) is added at a slow rate keeping the temp. between 0°-10° C. and the pH<2. After completion of the addition the mixture was stirred at <5° C. for 40 min. and excess nitrous acid quenched with sulfamic acid. In a separate vessel, 2-(2-ethylhexyloxy)-5-methylaniline (14.4 g, 61 mmol) is dissolved in acetone (100 ml) and crushed ice (80 g) added. The diazonium salt solution is then slowly added and the mixture stirred overnight, allowing to warm to ambient temperature. The formed solid is filtered off, and washed with water, before dissolving in dichloromethane (300 ml). The solution is washed with 1M KOH (80 ml) and water (80 ml), dried (MgSO₄) and evaporated to afford a dark oil. The crude oil is purified over silica gel, eluting with an increasing gradient of dichloromethane (30-50%) in heptane. Pure fractions are combined and evaporated, and the resultant oil dried under vacuum at 55° C. overnight. The pure title compound was obtained as a mobile dark oil (14.6 g, 61%).

### Step 4: 4-((E)-(4-((E)-(4-butylphenyl)diazenyl)-2-(2-ethylhexyloxy)-5-methylphenyl)diazenyl)-N,N-bis(2-ethylhexyl)-3-methylaniline

4-((4-Butylphenyl)diazenyl)-2-(2-ethylhexyloxy)-5-methylaniline (7.2 g, 18.1 mmol) is dissolved in a mixture of acetic acid (86 ml) and propionic acid (14 ml) and cooled in an ice bath to 2° C. To this is added 40% (w/w) nitrosyl sulfuric acid in sulfuric acid (6.9 g, 21.7 mmol) at <5° C. After 30 minutes stirring, the resultant solution is added slowly to a stirred mixture of N,N-di-(2-ethylhexyl)-m-toluidine (6.0 g, 18.1 mmol) acetone (200 ml), 10% aq. sulfamic acid (20 ml) and ice (100 g). After stirring overnight at ambient temperature, the mixture is diluted with hexane (200 ml) and poured into water (200 ml). The organic layer is separated, washed with 2N NaOH (150 ml), water (150 ml), dried (Na₂SO₄) and evaporated to afford a dark oil. The crude material is purified over silica gel, eluting with an increasing gradient of dichloromethane (20-30%) in hexane to afford the pure title compound as a black immobile oil (4.8 g, 36%); λₘₐₓ (hexane) 496 nm (37,500), FWHM 130 nm; ¹H NMR (CDCl₃, 300 MHz) δ 0.81-1.03 (21H, m), 1.20-1.76 (28H, m), 1.77-1.95 (3H, m), 2.62-2.79 (8H, m), 3.31 (4H, m), 4.08 (2H, d, J 6.5), 6.49-6.59 (2H, m), 7.21 (2H, d, J 9.0), 7.39 (1H, s), 7.55 (1H, s), 7.77 (1H, d, J 10.0), 7.87 (2H, d, J 9.0).

### Example 3

### 4-((E)-(4-((E)-(4-Butylphenyl)diazenyl)-3-(2-ethylhexyloxyl)phenyl)diazenyl)-N,N-bis(2-ethylhexyl)-3-methylaniline (Dye 15)

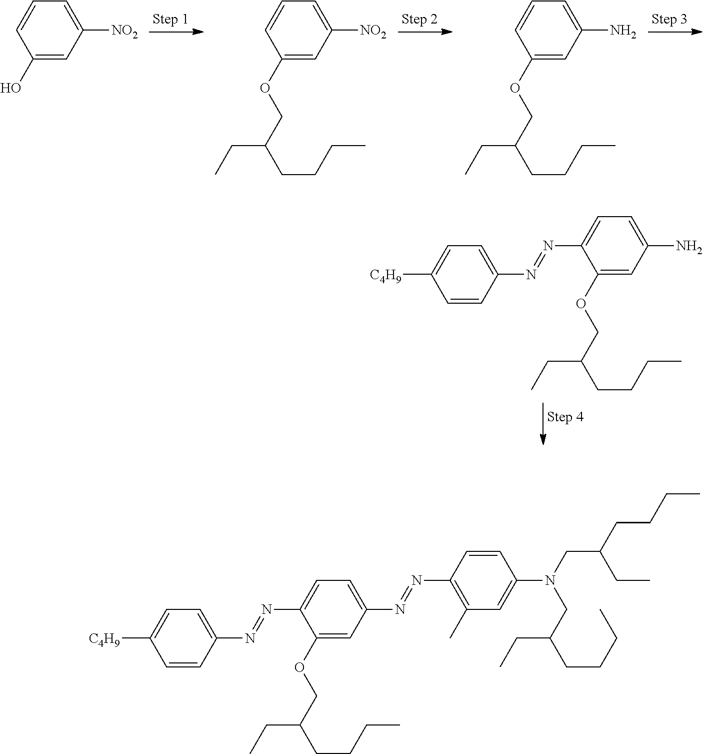

### Step 1: 1-(2-Ethylhexyloxy)-3-nitrobenzene

3-Nitrophenol (27.8 g, 0.20 mol) is dissolved in IMS (100 ml) and a solution of potassium hydroxide (12.3 g, 0.22 mol) in IMS (100 ml) is added, followed by 1-bromo-2-ethylhexane (42.5 g, 0.22 mol). The mixture is heated under reflux for 24 h, then allowed to cool and poured into a solution of potassium hydroxide (10 g) in water (1.5 L). The mixture is extracted with dichloromethane (2×300 ml), the organic layer is dried (MgSO₄) and evaporated to a free-flowing orange liquid. The crude material is diluted with hexane (200 ml), applied to a pad of silica gel (250 g) and washed with hexane (400 ml) before collecting the required product by eluting with 25% dichloromethane in hexane. Evaporation of solvent gave the required title compound as a free-flowing pale yellow oil (37.2 g, 74%), which was judged >99.5% pure by HPLC.

### Step 2: 3-(2-Ethylhexyloxy)aniline

1-(2-Ethylhexyloxy)-3-nitrobenzene (35.5 g, 0.14 mol) is dissolved in methanol (500 ml), 10% Pd/C catalyst is added under nitrogen and the mixture hydrogenated for 72 h under 1 atm. of hydrogen gas. The catalyst is filtered off and the solution evaporated to give the title compound as an orange oil (29.7 g, 95%). The material was judged >99.5% pure by HPLC.

### Step 3: 4-((4-Butylphenyl)diazenyl)-3-(2-ethylhexyloxy)aniline

4-Butylaniline (9.0 g, 60 mmol) is dissolved in 2-propanol (100 ml) and the stirred solution is cooled externally in an ice/salt bath to <5° C. (internal temp.). 5N Hydrochloric acid (45 ml) is added to this solution slowly and then sodium nitrite (4.35 g, 63 mmol) in water (15 ml) is added at a slow rate keeping the temp. between 0°-10° C. and the pH<2. After completion of the addition the mixture is stirred at <5° C. for 40 min. and excess nitrous acid is quenched with sulfamic acid (5 ml). In a separate vessel, 3-(2-ethylhexyloxy)aniline (14.0 g, 60 mmol) is dissolved in acetone (100 ml) and crushed ice (75 g) added. The diazonium salt solution is then slowly added and the mixture stirred overnight allowing to warm to ambient temp. The formed solid is filtered off, and washed with water, before dissolving in dichloromethane (300 ml). The solution is washed with 1M KOH (80 ml) and water (80 ml), dried (MgSO₄) and evaporated to afford a dark oil. The crude oil is purified over silica gel, eluting with dichloromethane. Pure product fractions are combined and evaporated, and the resultant oil dried under vacuum at 55° C. overnight. The pure title compound as obtained as a dark oil (3.7 g, 16%).

### Step 4: 4-((E)-(4-((E)-(4-Butylphenyl)diazenyl)-3-(2-ethylhexyloxyl)phenyl)diazenyl)-N,N-bis(2-ethylhexyl)-3-methylaniline

4-((4-Butylphenyl)diazenyl)-3-(2-ethylhexyloxy)aniline (3.7 g, 9.7 mmol) is dissolved in a mixture of acetic acid (86 ml) and propionic acid (14 ml) and cooled in an ice bath to 2° C. To this is added 40% (w/w)nitrosyl sulfuric acid in sulfuric acid (3.7 g, 11.6 mmol) at <5° C. After 2 h further stirring, the resultant solution is added slowly to a stirred mixture of N,N-di-(2-ethylhexyl)-m-toluidine (3.2 g, 9.7 mmol) acetone (50 ml), 10% aq. sulfamic acid (5 ml) and ice (50 g). After stirring overnight at ambient temperature, the mixture is diluted with hexane (250 ml) and poured into water (200 ml). The organic layer is separated, washed with 2N NaOH (50 ml) and water (100 ml), dried (MgSO₄) and evaporated to afford a dark oil. The crude material is purified over silica gel, eluting with an increasing gradient of dichloromethane (20-50%) in hexane to afford the pure title compound as a black oil (3.9 g, 55%); λₘₐₓ (hexane) 476 nm (39,250), FWHM 116 nm; ¹H NMR (CDCl₃, 500 MHz) δ 0.85-1.03 (21H, m), 1.21-1.73 (28H, m), 1.80-1.97 (3H, m), 2.68 (2H, t, J 7.0), 2.71 (3H, s), 3.33 (4H, m), 4.16 (2H, d, J 7.0), 6.51-6.60 (2H, m), 7.30 (2H, d, J 9.5), 7.48 (1H, dm, J 9.5), 7.55 (1H, d, J 1.0), 7.77 (2H, m), 7.87 (2H, d, J 9.5).

### Example 4

### N,N-Bis(2-ethylhexyl)-4-((E)-(3-methoxy-4-((E)-phenyldiazenyl)phenyl)diazenyl)-3-methylaniline (Dye 17)

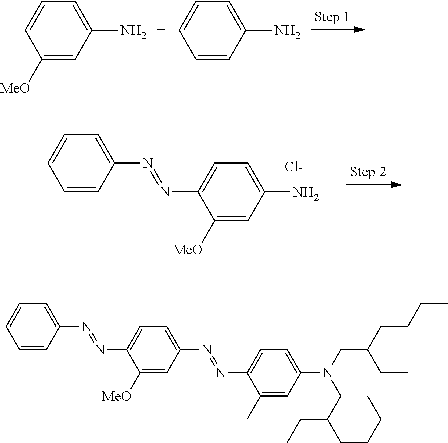 [SMILES: COc1cccc(N)c1 ; Nc1ccccc1 ; COc1cc([NH3+])ccc1/N=N/c1ccccc1 ; [Cl-] ; CCCCC(CC)CN(CC(CC)CCCC)c1ccc(/N=N/c2ccc(/N=N/c3ccccc3)c(OC)c2)c(C)c1]

### Step 1: (E)-3-Methoxy-4-(phenyldiazenyl)benzenaminium chloride

Aniline (18.6 g, 0.20 mol) is dissolved in 7% HCl (300 ml) and cooled to 2° C. 2M sodium nitrite solution (105 ml, 0.21 mol) is then added at 2-5° C. and the reaction stirred a further 30 minutes before excess nitrous acid is destroyed by the addition of 10% sulfamic acid solution (5 ml). m-Anisidine (29.8 g, 0.24 mol) is dissolved in methylated spirit (100 ml) and ice (100 g) added. The benzenediazonium chloride solution is then added dropwise, at 2-5° C. After stirring overnight, the resultant solid is collected by filtration, washed with water then triturated with acetone (1 L). Drying at 40° C. overnight gave the title compound as a red solid (45.4 g, 86%) which is judged >98% pure by HPLC at 420 nm.

### Step 2: N,N-Bis(2-ethylhexyl)-4-((E)-(3-methoxy-4-((E)-phenyldiazenyl)phenyl)diazenyl)-3-methylaniline

3-Methoxy-4-(phenyldiazenyl)benzenaminium chloride (6.82 g, 0.026 mol) is dissolved in acetic acid (20 ml) and propionic acid (10 ml), and cooled to 3° C. 40% nitrosyl sulfuric acid (11.43 g, 0.036 mol) is added dropwise at 2-5° C. and the mixture stirred a further 60 minutes. N,N-Di-(2-ethylhexyl)-m-toluidine (10.0 g, 0.030 mol) is dissolved in a mixture of methanol (50 ml), acetone (50 ml) and ice/water (50 g), and to this was added 10% sulfamic acid solution (20 ml). At <10° C., the diazonium salt solution is added portionwise and the resultant suspension stirred overnight. The solid is collected by filtration, washed with water (1 L) then partitioned between dichloromethane (500 ml) and 2N sodium hydroxide (100 ml). The organic phase was separated, rewashed with 2N sodium hydroxide (100 ml), then with water (2×150 ml), dried (MgSO₄) and concentrated in vacuo to afford a red oil, which is judged to be a ca 4:1 mixture of like-shaded products by HPLC at 480 nm. The crude oil is purified over silica gel, eluting with an increasing gradient of dichloromethane (5-20%) in hexane. The pure fractions are combined, concentrated in vacuo and the resultant semi-solid was recrystallised from dichloromethane/methanol, to give the title compound as a red semi-solid (1.9 g, 12%) mp=92-94° C.; λₘₐₓ (hexane) 478 nm (40,500), FWHM 116 nm; ¹H NMR (CDCl₃, 300 MHz) δ 0.96 (12H, m), 1.20-1.40 (16H, m), 1.86 (2H, m), 2.70 (3H, s), 3.32 (4H, m), 4.11 (3H, s), 6.55-6.60 (2H, m), 7.40-7.59 (5H, m), 7.78 (2H, m), 7.93 (2H, m).

### Example 5

### 4-((E)-(3-methoxy-4-((E)-phenyldiazenyl)phenyl)diazenyl)-3-methyl-N,N-ditetradecylaniline (Dye 16)

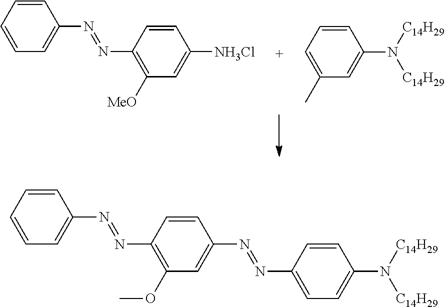

3-Methoxy-4-(phenyldiazenyl)benzenaminium chloride (4.5 g, 0.017 mol) (prepared according to the method described for example 4 step 1 above) is dissolved in acetic acid (86 ml) and propionic acid (14 ml), and cooled to <5° C.

40% Nitrosyl sulfuric acid (7.6 g, 0.024 mol) is added dropwise at 2-5° C. and the mixture stirred a further 2 h at <2-5° C. In a separate vessel, N,N-ditetradecyl-m-toluidine (10.0 g, 0.020 mol) is dissolved in acetone (400 ml) with gentle warming, 10% sulfamic acid solution (10 ml) is added, followed by ice/water (140 g). The diazonium salt solution is added portionwise and the resultant suspension stirred overnight. The solid is collected by filtration, washed with water (1 L) then partitioned between dichloromethane (500 ml) and 2N sodium hydroxide (100 ml). The organic phase is separated, rewashed with 2N sodium hydroxide (100 ml), then with water (150 ml), dried (MgSO₄) and concentrated in vacuo to afford a red gum. The crude material is purified over silica gel, eluting with an increasing gradient of dichloromethane (5-60%) in hexane. The pure fractions are combined, concentrated in vacuo and the resultant gum crystallised from dichloromethane/methanol, to give the title compound as a low melting red semi-solid (4.8 g, 38%); λₘₐₓ (hexane) 474 nm (35,250), FWHM 113 nm; ¹H NMR (CDCl₃, 300 MHz) δ 0.89 (6H, t, J 7.5), 1.22-1.40 (44H, m), 1.65 (4H, m), 2.72 (3H, s), 3.36 (4H, br. t, J 7.5), 4.11 (3H, s), 6.49-6.55 (2H, m), 7.41-7.56 (4H, m), 7.59 (1H, d, J 1.5), 7.79 (2H, m), 7.93 (2H, m).

### Example 6

### Preparation of Formulations and Testing

a) Dye mixtures using the novel dyes are prepared to obtain neutral black samples that can be used in EWD.
b) Solubility is measured by filtering an over-saturated sample of dissolved dye, measuring the resulting absorbance value, and extrapolating the concentration using a calibration curve and Beer Lambert Law (Absorbance=∈cl, where ∈ is the extinction coefficient of the material, calculated from a calibration curve, c is concentration, and l is the path length of the measurement).
c) The absorbance is measured using a Hitachi U3310 spectrophotometer with a 5 micron path length under a single pass transmission measurement condition.
d) The impact of the dye on the electrical properties is measured by comparing the dielectric constant of a series of formulations with increasing dye content. There is a linear relationship between dye concentration and dielectric constant, the gradient of which is indicative of the polarisability of the dye. This gradient value is denoted as an ‘alpha value’. A low alpha value indicates a smaller change in dielectric constant as dye concentration increases, and is desirable. High alpha values indicate that the dye has a large impact on the dielectric constant of the solvent, which will likely have a negative impact on the behaviour of the fluid in an electrowetting display pixel.

Data are summarised in Table 4. All compounds of the invention show high solubility and absorbance, and a low dielectric constant.

TABLE 4

| Dye | Colour | εₘₐₓ | Solubility % | Alpha value |
|---|---|---|---|---|
| Dye 1 | Blue/Black | 37343 | 0.22 | Cannot be |
| Comparative | | | | measured |
| Example | | | | due to poor |
| | | | | solubility |
| Dye 2 | Blue/Black | 40107 | 19.53 | 2.9360 |
| Dye 14 | Red/Black | 38954 | 28.66 | 1 2.366 |
| | (shader) | | | |

By mixing the dyes of the invention a neutral absorbing black can be achieved with high absorbance and an improved (lower) dielectric constant. Data are summarised in Table 5. The new mixture shows good absorbance and low dielectric constant.

TABLE 5

| | Measured | |
|---|---|---|
| | Absorbance | Dielectric |
| Mixture | (5 micron cell gap) | constant |
| Pure solvent | 0.000 | 1.98 |
| | | (literature |
| | | value) |
| Mixture of | 2.756 | 2.640 |
| Dye 2 and Dye 14 | | |

1.-16. (canceled)

17. An electrowetting fluid comprising a solvent or solvent mixture and at least one dye of Formula I and/or at least one dye of Formula II 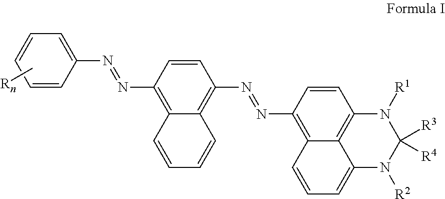
wherein
R=independently linear or branched, substituted or unsubstituted, saturated or unsaturated or chiral alkyl or cycloalkyl, OR′, or an electron-withdrawing group, and n=1-5 and R′=independently linear or branched alkyl;
R¹ and R²=independently linear or branched, substituted or unsubstituted alkyl, where one or more non-adjacent carbon atoms is optionally replaced by O, S and/or N, substituted or unsubstituted cycloalkyl, substituted or unsubstituted aryl,
R³ and R⁴=independently H or linear or branched, substituted or unsubstituted alkyl, substituted or unsubstituted cycloalkyl, substituted or unsubstituted aryl, or R³ and R⁴ forming a cycloaliphatic ring; 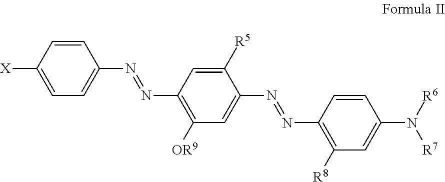
wherein
X=H or linear or branched, substituted or unsubstituted alkyl or substituted or unsubstituted cycloalkyl;
R⁵=H or linear or branched, substituted or unsubstituted alkyl, substituted or unsubstituted cycloalkyl, or substituted or unsubstituted aryl,
R⁶ and R⁷=independently linear or branched, substituted or unsubstituted alkyl, substituted or unsubstituted cycloalkyl, substituted or unsubstituted aryl,
R⁸=H or linear or branched, substituted or unsubstituted alkyl, substituted or unsubstituted cycloalkyl or substituted or unsubstituted aryl, or CH₃NH—CO—O— and
R⁹=linear or branched, substituted or unsubstituted alkyl.

18. The electrowetting fluid according to claim 17, wherein R is C1-C12 alkyl.

19. The electrowetting fluid according to claim 17, wherein R¹ and R² are independently aryl or C1-C15 alkyl.

20. The electrowetting fluid according to claim 17, wherein R³ and R⁴ are independently aryl or C1-C20 alkyl.

21. The electrowetting fluid according to claim 17, wherein X is C1-C15 alkyl or cycloalkyl.

22. The electrowetting fluid according to claim 17, wherein R⁵ is H or C1-C6 alkyl.

23. The electrowetting fluid according to claim 17, wherein R⁶ and R⁷ are independently C1-C20 alkyl.

24. The electrowetting fluid according to claim 17, wherein R⁸ is C1-C6 alkyl.

25. The electrowetting fluid according to claim 17, wherein R⁹ is C1-C20 alkyl.

26. The electrowetting fluid according to claim 17, wherein R is C1-C6 alkyl,
R¹ and R² are independently C2-C12 alkyl,
R³ and R⁴ are independently C1-C15 alkyl,
X is C1-C8 alkyl or cycloalkyl,
R⁵ is H or C1-C3 alkyl,
R⁶ and R⁷ are independently C6-C15 alkyl,
R⁸ is C1-C3 alkyl and
R⁹ is C1-C15 alkyl.

27. The electrowetting fluid according to claim 17, wherein the fluid additionally comprises at least one dye according to Formula III 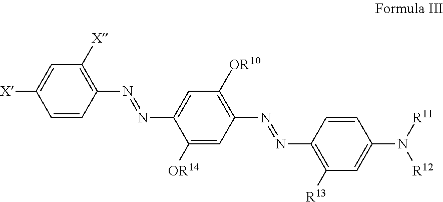
wherein
X′ and X″ are independently of one another H or an electron-withdrawing group;
R¹⁰ and R¹⁴ are independently groups are linear or branched, substituted or unsubstituted alkyl groups where one or more non-adjacent carbon atoms is optionally replaced by O, S and/or N;
R¹¹ and R¹² are independently groups are linear or branched, substituted or unsubstituted alkyl groups where one or more non-adjacent carbon atoms is optionally replaced by O, S and/or N;
R¹³ is a methyl or methoxy group;
and the dye comprises at least one electron-withdrawing group;

28. The electrowetting fluid according to claim 17, wherein the fluid comprises at least one non-polar solvent having a dielectric constant<10, volume resistivity about 10¹⁵ ohm-cm, viscosity<5 cst, and a boiling point>80° C.

29. A method of displaying an image with the electrowetting fluid according to claim 17.

30. A process for the preparation of a mono, bi or polychromal electrowetting display device which comprises utilizing the electrowetting fluid according to claim 17.

31. An electrowetting display device comprising the electrowetting fluid according to claim claim 17.

32. The electrowetting display device according to claim 31, wherein the electrowetting fluid is applied by a technique selected from inkjet printing, slot die spraying, nozzle spraying, and flexographic printing, or any other contact or contactless printing or deposition technique.

33. A dye according to Formula I or Formula II 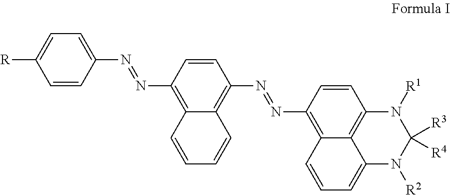
wherein
R=linear or branched, substituted or unsubstituted, saturated or unsaturated alkyl or cycloalkyl,
R¹ and R²=independently linear or branched, substituted or unsubstituted alkyl, substituted or unsubstituted cycloalkyl, substituted or unsubstituted aryl,
R³ and R⁴=independently H or linear or branched, substituted or unsubstituted alkyl, substituted or unsubstituted cycloalkyl, substituted or unsubstituted aryl, or R³ and R⁴ forming a cycloaliphatic ring; 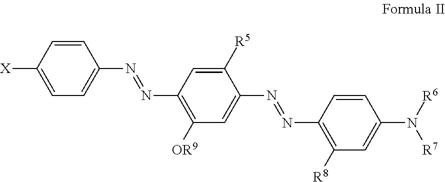
wherein
X=H or linear or branched, substituted or unsubstituted alkyl or substituted or unsubstituted cycloalkyl;
R⁵=H or linear or branched, substituted or unsubstituted alkyl, substituted or unsubstituted cycloalkyl, or substituted or unsubstituted aryl,
R⁶ and R⁷=independent of each other linear or branched, substituted or unsubstituted alkyl, substituted or unsubstituted cycloalkyl, substituted or unsubstituted aryl,
R⁸=H or linear or branched, substituted or unsubstituted alkyl, substituted or unsubstituted cycloalkyl or substituted or unsubstituted aryl, and
R⁹=linear or branched, substituted or unsubstituted alkyl.
